(19) United States
(12) Patent Application Publication
(10) Pub. No.: US 2026/0123675 A1
(43) Pub. Date: May 7, 2026

(54) Vaporization Battery Assembly

(71) Applicant: Rodrigo Escorcio Santos, Rockville, MD (US)

(72) Inventor: Rodrigo Escorcio Santos, Rockville, MD (US)

(21) Appl. No.: 19/372,762

(22) Filed: Oct. 29, 2025

Related U.S. Application Data
(60) Provisional application No. 63/715,810, filed on Nov. 4, 2024.

(51) Int. Cl. A24F 40/40; A24F 40/60; H01M 50/107; H01M 50/131

(52) U.S. Cl. CPC A24F 40/40; A24F 40/60; H01M 50/107; H01M 50/131; H01M 2220/30

(57) ABSTRACT

A vaporization device includes a tank and a battery. The tank is configured to receive a starting material, and the battery is configured to provide electric power to the tank so that the tank heats the starting material to produce an inhalable vapor. The battery includes a first portion and a second portion configured to removably couple to one another. Thus, the second portion can readily decouple from the first portion to enable an additional second portion to be coupled to the first portion.

### CROSS-REFERENCE

This application claims priority to and the benefit of U.S. Provisional Patent Application No. 63/715,810, entitled “Vaporization Battery Assembly,” filed Nov. 4, 2024, which is hereby incorporated in its entirety for all purposes.

### TECHNICAL FIELD

The present disclosure is directed toward a vaporization device and, in particular, to a battery assembly of a vaporization device.

### BACKGROUND

Vaporization devices are commonly used to consume an inhalable vapor. For such devices, the inhalable vapor can be formed from various starting materials, such as oils, concentrates, and/or combustible plant substances, which are initially in a solid or liquid state. The vaporization device heats and vaporizes the starting material to form the inhalable vapor, and the inhalable vapor is discharged from the vaporization device and consumed by a user. As vaporization devices become increasingly popular, it is desirable to increase customization and/or personalization of the vaporization devices, such as to provide a particular aesthetic appearance, without increasing a manufacturing burden or complexity.

### SUMMARY

A vaporization device for an inhalable product is presented herein. According to at least one embodiment, the vaporization device includes a tank with a heater. The tank is configured to receive a starting material, and the heater is configured to heat and vaporize the starting material to produce an inhalable vapor. The vaporization device also includes a battery configured to provide electric power to the tank to operate the heater to heat and vaporize the starting material. The battery has a first portion and a second portion configured to couple to one another, the first portion is attached to the tank, and the first portion and the second portion are configured to removably couple to one another. This enables the second portion to be adjusted, such as to couple an additional second portion to the first portion, which may enable greater customization of the battery.

According to another embodiment of the present disclosure, a battery for a vaporization device is presented herein. The battery includes a first portion containing power-related components and a battery cell. The first portion being configured to provide electric power to a tank of the vaporization device to operate a heater for vaporizing a starting material to produce an inhalable vapor. The battery also includes a second portion configured to removably couple to the first portion to enable an additional second portion to be coupled to the first portion, which may enable greater customization of the battery.

According to yet another embodiment of the present disclosure, a kit for a vaporization device is presented herein. The kit includes a first portion of a battery, a second portion of the battery, and an additional second portion of the battery. The first portion is configured to provide electric power to a tank of the vaporization device to operate a heater for vaporizing a starting material to produce an inhalable vapor. The second portion and the additional second portion are each configured to removably couple to the first portion such that the second portion and the additional second portion are interchangeably couplable to the first portion. This may enable greater customization of the battery, such as by enabling the second portion and the additional second portion to be selectively coupled to the first portion.

### BRIEF DESCRIPTION OF THE DRAWINGS

FIG. 1 is a front view of a vaporization device with a tank and a battery configured to couple to one another, in accordance with an example embodiment of the present disclosure.

FIG. 2 is a front view of a battery of a vaporization device in an assembled configuration, in accordance with an example embodiment of the present disclosure.

FIG. 3 is a front view of the battery of FIG. 2 in a disassembled configuration, in accordance with an example embodiment of the present disclosure.

FIG. 4 is a front view of another battery of a vaporization device, in accordance with an example embodiment of the present disclosure.

FIG. 5A is a portion of yet another battery of a vaporization device, in accordance with an example embodiment of the present disclosure.

FIG. 5B is a further battery of a vaporization device, in accordance with an example embodiment of the present disclosure.

FIG. 5C is still another battery of a vaporization device, in accordance with an example embodiment of the present disclosure.

FIG. 6 is a front view of another vaporization device with a tank and a battery, in accordance with an example embodiment of the present disclosure.

Like reference numerals have been used to identify like elements throughout this disclosure.

### DETAILED DESCRIPTION

Present herein is a vaporization device for an inhalable product. The vaporization device includes a tank configured to receive a starting material and vaporize at least a portion of the starting material to produce an inhalable vapor. The tank is configured to discharge the inhalable vapor for consumption by a user.

The vaporization device also includes a battery configured to couple to the tank. The battery is configured to provide electric power to the tank to enable the tank to vaporize the starting material. In some cases, it is desirable to change a design of the battery. That is, it is desirable for the appearance of the battery to be easily changed after manufacture. This may increase customization of the battery.

Accordingly, the present application is directed to a battery with features that may enable an aesthetic appearance of the battery to be more easily changed. To this end, the battery includes a first portion and a second portion configured to couple to one another. The second portion may be easily detachable from the first portion to enable a different second portion to be coupled to the first portion. Each different second portion may provide a different aesthetic appearance of the battery. As an example, each second portion may have a different look such that changing the second portion attached to the first portion changes the appearance of the battery. Additionally or alternatively, different design elements may be applied to and/or positioned in a second portion, and decoupling the second portion from the first portion may enable different design elements to be implemented. In either case, the second portion may be selectively coupled to and decoupled from the first portion to change an appearance of the battery, even after the battery (e.g., the first portion) has been manufactured. Indeed, the adjustability of the battery may enable the appearance of the battery to change without having to manufacture and implement different embodiments of an entire battery, thereby avoiding a cost/complexity associated with producing different looking batteries.

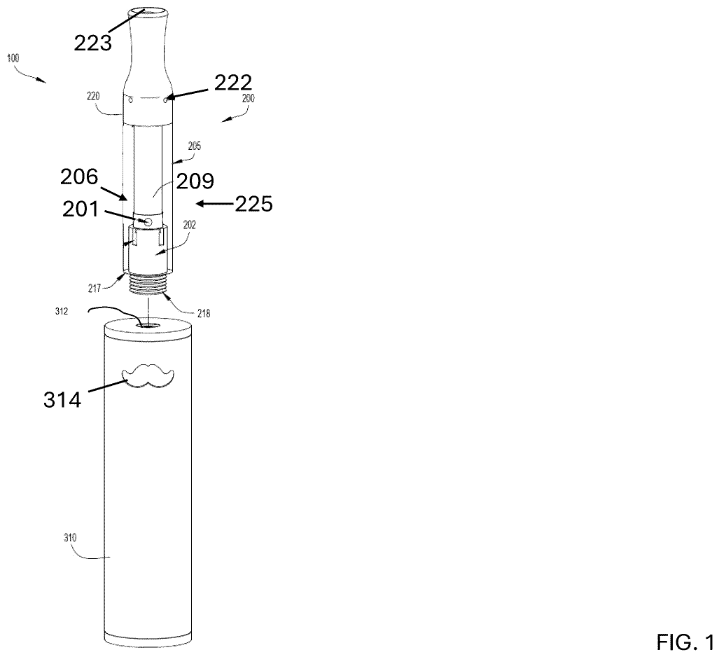

FIG. 1 is a perspective view of a vaporization device 100 that includes a tank 200 and a battery 310 configured to couple to the tank 200. The tank 200 includes a tank enclosure 205 and a heater or heating element 202 (e.g., an atomizer) that is disposed within (e.g., sealed within) the tank enclosure 205. The heater 202 is fluidly connected to a discharge portion 220 (e.g., a mouthpiece) of the tank 200 via a chimney 209. In the depicted embodiment, each of the tank enclosure 205, the heater 202, and the chimney 209 are cylindrical. However, in other embodiments, these components could have other shapes. The tank 200 includes a chamber 206 formed between the tank enclosure 205 and the combination of the heater 202 and the chimney 209. The chamber 206 can be filled with a starting material (e.g., a liquid, such as an oil and/or a concentrate, a solid, such as a combustible plant substance) and is sealed to block undesirable flow of the starting material out of the chamber 206. To this end, the tank enclosure 205, the chimney 209, and the heater 202 cooperatively define a seal between outer surfaces of the heater 202 and of the chimney 209 and an inner surface of the tank enclosure 205. Consequently, in the depicted embodiment, the chamber 206 is an annular chamber that extends around the heater 202 and chimney 209.

Channels 201 are formed in a liner surrounding the heater 202 to enable flow of the starting material from the chamber 206 into an interior of the heater 202 that is separate and distinct from the chamber 206. The heater 202 then provides heat that vaporizes a portion of the starting material within the interior of the heater 202 to produce an inhalable vapor. In some embodiments, the heater 202 (e.g., a heating coil) can conductively heat the starting material. Additionally or alternatively, the heater 202 (e.g., a magnetic coil) can inductively or electrically heat the starting material. The heater 202 is sealingly engaged with the chimney 209 to block the starting material from entering the interior of the chimney 209 without passing through the channels 201 and the heater 202 and undergoing a phase change to vapor as a result. Accordingly, the coupling between the heater 202 and the chimney 209 may ensure that vapor (e.g., instead of liquid) flows through the heater 202 and toward the chimney 209.

The interior of the heater 202 is fluidly connected to an interior of the chimney 209 to enable the inhalable vapor to flow from the heater 202 into the interior of the chimney 209. For instance, production of the inhalable vapor within the interior of the heater 202 may increase the pressure within the interior of the heater 202 (e.g., to a greater pressure than that in the interior of the chimney 209) to force the inhalable vapor to flow from the interior of the heater 202 to the interior of the chimney 209. Additionally, the interior of the chimney 209 is fluidly connected to an interior of the discharge portion 220. Airflow openings 222 are formed through the discharge portion 220 to enable ambient air to enter the tank 200 and encourage a flow of the inhalable vapor out of the tank 200 through an outlet 223 (e.g., after flowing through the heater 202 and the chimney 209).

The chamber 206, the interior of the heater 202, the interior of the chimney 209, and the interior of the discharge portion 220 cooperatively form a reservoir 225 in which the starting material is positioned and undergoes a phase change to vapor to provide the inhalable vapor. That is, the tank enclosure 205, the heater 202, the chimney 209, and the discharge portion 220 cooperatively define the reservoir 225 where the starting material is heated to produce the inhalable vapor, and the outlet 223 enables the inhalable vapor to flow out of the reservoir 225 and the tank 200 for discharge from the vaporization device 100. Thus, in the illustrated embodiment, the heater 202 is integral with the reservoir 225 (e.g., as a part of the tank 200).

However, in some embodiments, the heater 202 and the reservoir 225 can be separate from one another. For instance, the heater 202 may be external to the tank 200, and other components (e.g., the tank enclosure 205, the chimney 209, the discharge portion 220) may define the reservoir 225. In such embodiments, the heater 202 may heat the starting material (e.g., by conducting heat through the tank enclosure 205) in the reservoir 225 to provide the inhalable vapor, and the inhalable vapor may flow through at least a portion of the reservoir 225 (e.g., through the chimney 209, through the discharge portion 220) without flowing through the heater 202. Additionally, the tank 200 may be easily decoupled from the heater 202 in such embodiments, such as to enable replacement of the tank 200 (e.g., to replace a tank 200 after the starting material in the tank 200 has been depleted such that no further inhalable vapor can be produced). The heater 202 may remain as a part of the vaporization device 100 and may therefore be able to heat multiple different tanks 200. Thus, manufacture and implementation of multiple heaters 202 is avoided.

In further embodiments, the reservoir 225 of the tank 200 may be easily accessible to enable refill of a starting material within the reservoir 225. By way of example, the discharge portion 220 may be decoupled from the tank enclosure 205 to expose an interior of the reservoir 225 and enable an additional starting material to be placed within the reservoir 225. In such embodiments, the reservoir 225 may be refilled without having to remove a substantial portion of the tank 200 from the vaporization device 100.

The heater 202 is configured to electrically couple to the battery 310 to enable the battery 310 to provide electric power to operate the heater 202 to vaporize the starting material. The battery 310 is configured to store electric power and transmit stored electric power to the heater 202, such as in response to a user input. For example, the battery 310 may include an actuator, such as a button and/or a switch, and a user may initiate operation of the vaporization device 100 by actuating the actuator to cause electricity to flow from the battery 310 to the heater 202. The battery 310 may include a single battery (e.g., a 510 thread battery) or may be configured to house multiple batteries, such as AA, AAA, C, D, and/or rechargeable batters (e.g., a lithium-ion 18650 cell battery).

The battery 310 may be configured to provide power for multiple tanks 200. For example, a first tank 200 initially coupled to the battery 310 may be decoupled from the battery 310 (e.g., after the starting material in the first tank 200 has been depleted), and a second tank 200 may be coupled to the battery 310 instead. However, it should be noted that the present disclosure is not limited to a battery that is removably couplable to a tank and may also apply to a battery that is irremovably coupled to a tank (e.g., provided with the tank as a disposable unit).

In the illustrated embodiment, the tank 200 includes an extension 218 extending from an end 217 (e.g., a bottom surface) of the tank 200. The extension 218 is configured to be inserted into an opening 312 of the battery 310 to couple the tank 200 to the battery 310, which electrically couples the heater 202 to the battery 310. For instance, the extension 218 may be threaded and may threadedly couple to corresponding threads formed around the opening 312 to secure the tank 200 and the battery 310 to one another. However, the tank 200 may be secured to the battery 310 using any other suitable feature, such as a fastener, a latch, and so forth, to electrically couple the heater 202 to the battery 310.

The battery 310 includes a design 314, such as an identifier (e.g., a company logo), a design element, an advertising material, and/or an ornament. The battery 310 is adjustable to change the design 314. For instance, a user may desire to change an aesthetic look of the battery 310. The battery 310 enables the user to selectively implement a desirable design 314 using techniques discussed further herein.

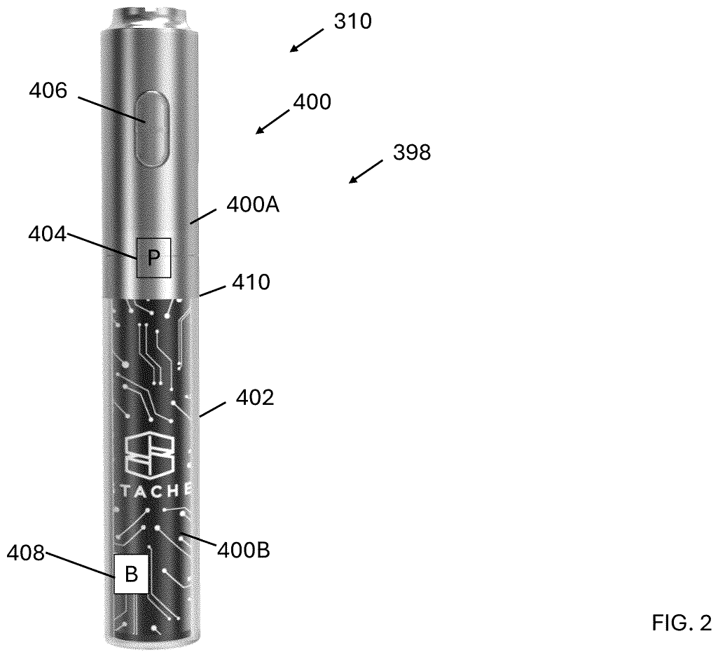

FIG. 2 is a front view of the battery 310 in an assembled configuration 398 (e.g., a fully assembled configuration). The illustrated battery 310 includes a first portion 400 (e.g., a fixed portion, a main body) and a second portion 402 (e.g., a removable portion, a shell) configured to couple to one another in the assembled configuration 398. The first portion 400 is configured to couple to the tank 200 and is therefore configured to provide electric power to the heater 202 of the tank 200. To this end, the first portion 400 includes power-related components 404, such as a PCB board, a charging port, and so forth, to manipulate electricity for delivery to the heater 202. The first portion 400 also includes the opening 312 to mechanically secure to the tank 200, as well as an actuator 406 (e.g., a button) with which a user may interact to cause the battery 310 to deliver electric power to the heater 202. In some embodiments, a first section 400A (e.g., an interface section) of the first portion 400 includes each of the power-related components 404, the actuator 406, and the opening 312.

The first portion 400 also includes a second section 400B (e.g., an extended section) extending from the first section 400A. The second section 400B may, for instance, house a battery cell 408. Moreover, the second section 400B may be or may include a waterproof casing/coating that helps seal the battery cell 408 and the power-related components 404 disposed in the first portion 400.

Meanwhile, the second portion 402 is configured to be removably coupled to the first portion 400. In particular, the second portion 402 is configured to contact and interface with a mount 410 of the first section 400A and surround the second section 400B while coupled to the first section 400A. The second portion 402 may readily detach from the first portion 400, such as to attach a different section portion 402 to the first portion 400. As an example, the second portion 402 provides a certain aesthetic look for the battery 310, and a different second portion 402 may be attached to the first portion 400 to provide a different aesthetic look for the battery 310. Therefore, the second portion 402 may be easily changed to customize an appearance of the battery 310.

In certain embodiments, the mount 410 of the first section 400A and a part of the second portion 402 configured to contact the mount 410 is composed of a material (e.g., a metal) to provide a secure connection between the first portion 400 and the second portion 402. Meanwhile, a remainder of the second portion 402 may be composed of a material to provide a certain aesthetic appearance. For example, the second portion 402 may be composed of a glass and/or plastic material to provide a transparent, a partially transparent, and/or a translucent shell, which gives the battery 310 a certain aesthetic appearance (e.g., to enable at least partial visibility of the second section 400B, such as a paper decoration applied to the second section 400B, extending within the second portion 402). In the illustrated embodiment, the second section 400B includes design indicia, which may be applied to the second section 400B via printing, etching, marking, or other such techniques, and the design indicia can be seen through the second portion 402. In additional or alternative embodiments, the second section 400B may be covered with a design element, such as a wrap (e.g., to change a visible design and/or branding of the battery 310). However, the second portion 402 may be composed of any other material to provide a particular aesthetic appearance. For instance, one or both of the first portion 400 or the second portion 402 may be composed of a metal, a plastic, a wood, a glass, and/or a composite.

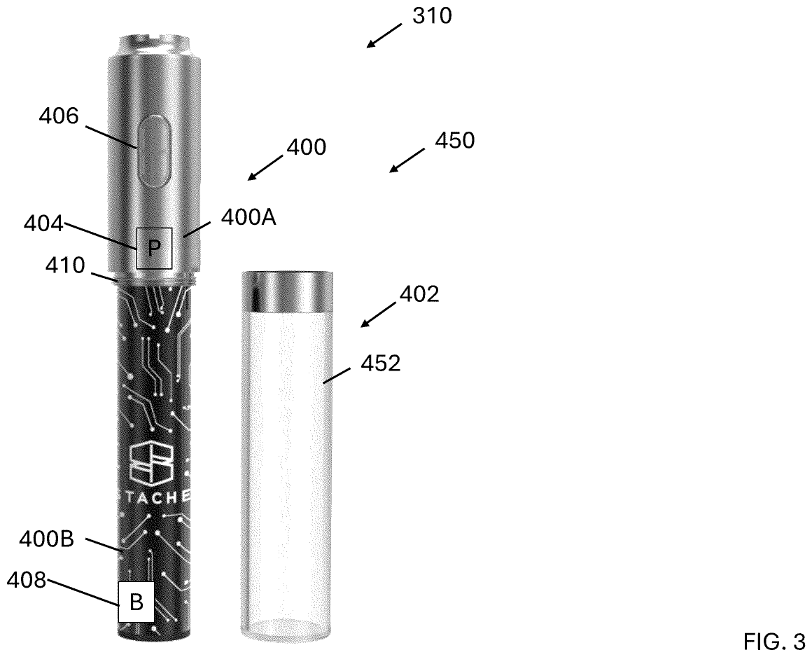

FIG. 3 is a front view of the battery 310 in a disassembled configuration 450 (e.g., a partially disassembled configuration) in which the second portion 402 is decoupled from the first portion 400. In certain embodiments, the mount 410 includes threads, and the second portion 402 includes corresponding threads to threadedly engage the mount 410, thereby coupling the first portion 400 and the second portion 402 to one another. In such embodiments, the second portion 402 is readily able to be decoupled from the threads of the mount 410 to decouple from the first portion 400. Moreover, in other embodiments, the second portion 402 is configured to couple to and decouple from the mount 410 using any other suitable feature, such as a magnetic connection, an interference fit, a detent lock, a quick-lock connection, a hinged coupling, a flexible coupling, a quick disconnect, and the like, to enable the second portion 402 to be removably installed around the second section 400B and releasably secured to the first section 400A.

Decoupling the second portion 402 from the first portion 400 exposes the second section 400B and the mount 410 in the illustrated embodiment. Consequently, a different second portion 402, such as a second portion 402 providing a different aesthetic appearance for the battery 310, may be able to couple to the first portion 400 via the mount 410.

As an example, a second portion 402 having a branding (e.g., the design 314), which may be applied via printing, etching, marking, or other such techniques to a surface of the second portion 402, may be coupled to the first portion 400. Such a second portion 402 may cover and reduce visibility of the second section 400B. For instance, the second portion 402 may be partially transparent around a portion of a circumference, at a certain axial extension, or in any other manner (e.g., with transparent slits, gaps, other viewing openings) such that the second portion 402 reduces full visibility of the second section 400B of the first portion 400.

As another example, the second portion 402 may have a different shape and/or size. For instance, a second portion 402 with a particular geometric shape may be implemented to provide a certain grip feel for a user and enable the user to couple the battery 310 to the tank 200, to hold the vaporization device via the battery 310, and so forth, more easily.

Additionally or alternatively, coupling the second portion 402 to the first portion 400 defines a cavity/gap (e.g., an annular cavity between 1-10 millimeters in thickness) between a wall 452 of the second portion 402 and the second section 400B, and the cavity is configured to support a visual effect. That is, the cavity is cooperatively defined by concentric and/or non-concentric surfaces of the second section 400B and the second portion 402. The cavity may receive various components, such as a light emitter, a fluid (e.g., a suspended fluid), a solid, a design element, and the like, and the wall 452 of the second portion 402 is at least partially transparent to enable the components in the cavity to be viewed to support the visual effect. The second section 400B may be suitably shaped (e.g., sized) to enable the cavity to accommodate the components providing the visual effect. By way of example, the second section 400B may be shaped to create multiple compartments of a cavity while the second portion 402 is coupled to the first portion 400, and the compartments may be separated by one another to receive different components. In such embodiments, different components may be visible at different locations (e.g., different viewing angles) of the battery 310 to provide various visual effects.

Further, in certain embodiments, the first portion 400 may not include the second section 400B. Thus, the second portion 402 is configured to couple to the first portion 400 without having to surround a significant part of the first portion 400. For example, the second portion 402 may define a substantially empty chamber used to support a visual effect (e.g., by receiving components providing the visual effect).

Further still, the first portion 400 may also provide certain visual effects. For instance, the first section 400A may be at least partially transparent/translucent, which may enable at least some of the power-related components 404 and/or the battery cell 408 to be visible. Additionally or alternatively, the first portion 400 may support or create any visual effects discussed herein.

In any case, different second portions 402 may be interchangeably coupled to the first portion 400. This enables greater customization of the battery 310. By way of example, a user (e.g., a manufacturer, a producer, a distributor) may provide customer-specific branding by coupling a particular second portion 402 to the first portion 400. Consequently, instead of having to, for instance, manufacture and keep inventory of different embodiments of an entire battery (e.g., the portions containing power-related components and/or a battery cell) dedicated to provide different aesthetic appearances, a single embodiment of the first portion 400 configured to couple to different looking second portions 402 may be used to provide different aesthetic appearances of the battery 310. For this reason, different looking batteries 310 may be more easily manufactured, such as without having to order/manufacture a specific quantity of different looking first portions 400 (e.g., and therefore avoid having to require minimum order limits to reduce costs for manufacturing a certain embodiment of the first portion 400) or be hindered by any other quantity-imposed limitation for provision of the battery 310. Indeed, because the second portion 402 may be much more easily manufactured than the first portion 400, changing the aesthetic appearance of the battery 310 by manufacturing different second portions 402 (e.g., by installing a wrap or other design element within the wall 452) without having to manufacture a substantial quantity of different first portions 400 may reduce costs associated with providing different looking batteries 310. That is, a limited quantity of different embodiments of the first portion 400 may be maintained to reduce a complexity associated with manufacturing different batteries 310.

Indeed, users may selectively change the appearance of the battery 310 as desired, such as to provide different functions, convey different information, and/or change the style of the battery 310. This may enable greater personalization and satisfaction. In some instances, design elements (e.g., branding materials, rolled/wrapped up paper with printed designs, stickers, decals, beads, orbs, blocks) may be installed between the second section 400B and the wall 452 while the second portion 402 is coupled to the first portion 400, and the design elements may be removed while the second portion 402 is decoupled from the first portion 400 (e.g., to install different design elements). For example, the design elements may be applied to (e.g., wrapped around) an external surface of the second section 400B and/or the design elements may be applied to an internal surface of the wall 452. Regardless, in such implementations, the same second portion 402 may enable different aesthetic appearances of the battery 310 to be provided by changing the design elements being implemented.

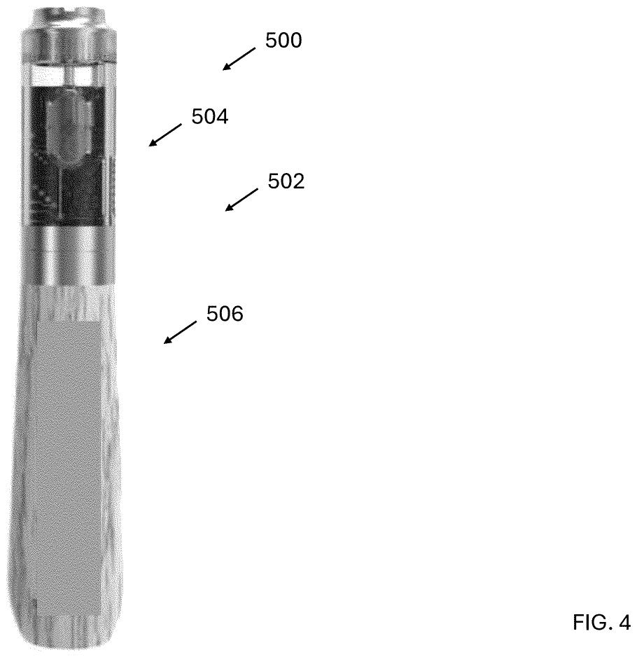

FIG. 4 is a front view of another example battery 500 in an assembled configuration 502. The battery 500 includes a first portion 504 and a second portion 506 coupled to one another in the assembled configuration 502. In certain embodiments, the first portion 504 of the battery 500 is of the same embodiment as that of the first portion 400 of the battery 310. However, the second portion 506 of the battery 500 is of a different embodiment than that of the second portion 402 of the battery 310. For example, the battery 500 may be provided by decoupling the second portion 402 from the first portion 400 and coupling the second portion 506 to the first portion 400.

The illustrated second portion 506 has a wood-grain aesthetic appearance that is substantially opaque. Thus, the first portion 504 is not visible through the second portion 506. Additionally, the second portion 506 has a tapered or flared surface. This may provide a different (e.g., more suitable) grip feel for a user grasping the second portion 506.

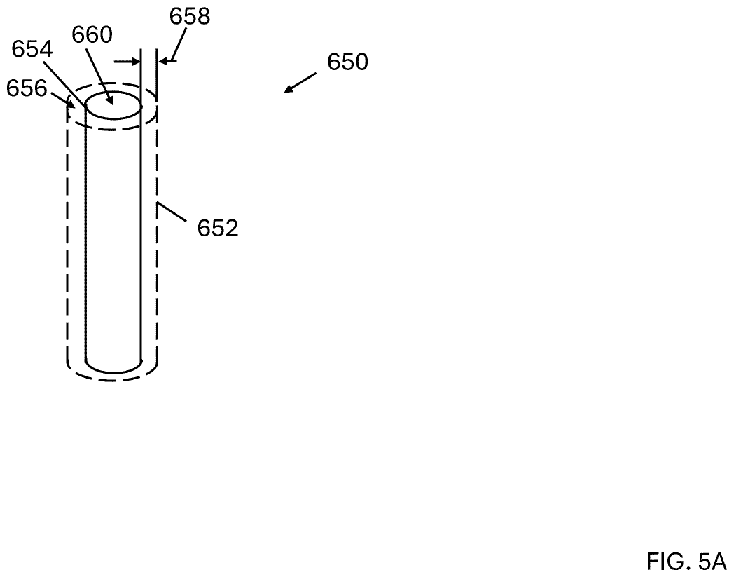

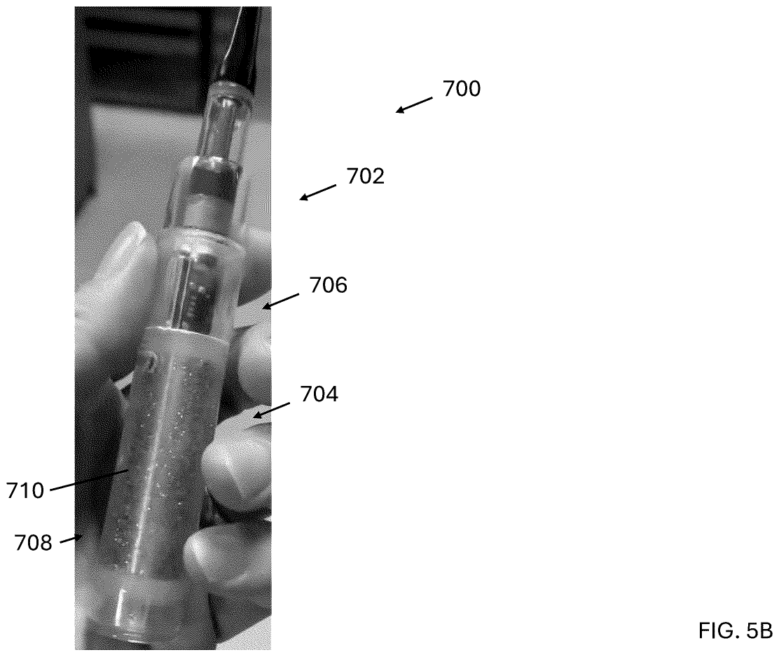

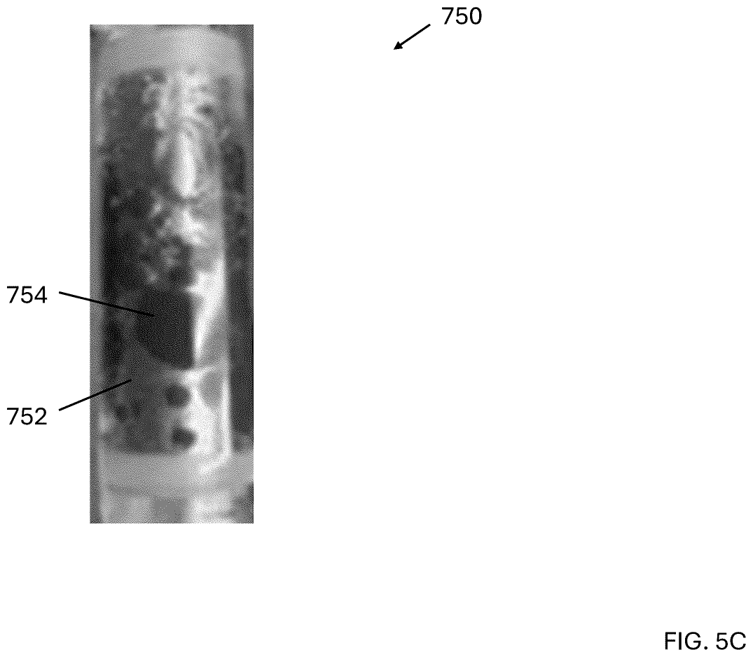

In other embodiments, a battery may have a particular structural configuration to provide a desirable visual effect. FIG. 5A is a schematic illustration of a second portion 650 (e.g., representative of the second portion 402) of a battery, the second portion 650 being configured to couple to any suitable first portion, such as the first portion 504 and/or the first portion 400, configured to provide electric power to a tank. The second portion 650 includes an outer wall 652 (shown in phantom lines) surrounding an inner wall 654. Thus, the outer wall 652 and the inner wall 654 cooperatively define a space/chamber 656 therebetween. The space 656 is configured to receive materials, such as a fluid, a solid, suspended materials, a combination of materials, and the like. Such materials may move within the space 656 to produce a unique visual effect, such as a Rayleigh-Taylor instability interaction (e.g., a motion lamp effect), bubbling, a snow globe effect, a neon glow, and the like. As an example, the space 656 may be annular and have a thickness 658 between 1 and 10 millimeters. In some embodiments, the inner wall 654 includes an opening 660 configured to receive part of a first portion of a battery to secure the first portion and the second portion 650 to one another, such as via a threaded connection.

FIG. 5B is a front perspective view of a vaporization device 700 that includes a tank 702 and a battery 704 coupled to one another. The battery 704 includes a first portion 706 and a second portion 708 coupled to one another. The second portion 708 has a similar configuration to that of the second portion 650. Specifically, the second portion 708 has two walls defining a space that is filled with materials 710 (e.g., a liquid with glitter particles) to produce a unique visual effect.

FIG. 5C is a front perspective view of a second portion 750 that has a similar configuration to that of the second portion 650. That is, the second portion 750 has two walls defining a space that is filled with materials 752 to produce a unique visual effect. For instance, the materials 752 may include two fluids with different densities that interact with one another to provide Rayleigh-Taylor instability. The fluids may move within the space, such as in response to a gravitational force (e.g., as the orientation of the second portion 750 changes during usage), which creates the unique visual effect. For instance, moving the fluids may produce bubbles 754 within the second portion 750.

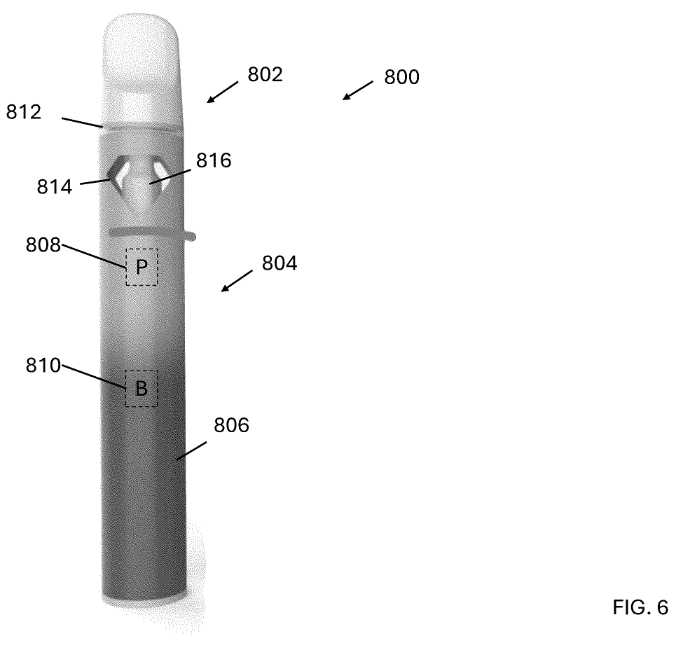

Furthermore, while embodiments presented herein primarily discuss implementations in which a battery and a tank are configured to couple (e.g., removably couple) to one another, features discussed herein may be incorporated in embodiments in which a battery and a tank are fixed or integral with one another, such as for a disposable vaporization device. In such embodiments, the battery includes a first portion (e.g., a fixed portion, which may be any of the first portions 400, 504, 706) fixed to the tank and a second portion (e.g., a removable portion, which may be any of the second portions 402, 506, 708) configured to removably couple to the first portion and/or to the tank. Consequently, different second portions may be interchangeably coupled to the first portion, such as to provide a particular aesthetic appearance of the vaporization device. Regardless, a first portion of a battery is attached to (e.g., fixed to, integral with, removably coupled to) a tank, and a second portion of the battery is removably coupled to the first portion (e.g., by removably coupling to the tank). FIG. 6 illustrates an embodiment of a vaporization device 800 having a tank 802 and a battery 804 that are at least partially integrated with or fixed to one another.

In particular, a second portion 806 of the battery 804 is configured to removably couple to the tank 802 at a mount 812 (e.g., via threads) to surround a first portion (not shown) of the battery 804 and/or part of the tank 802. Therefore, the second portion 806 of the battery 804 may enclose and shield at least part of the first portion of the battery 804 and/or part of the tank 802, which may protect power-related components 808 and/or a battery cell 810 disposed in the first portion of the battery 804. The illustrated second portion 806 is also primarily opaque to cover visibility of the first portion of the battery 804. For instance, the second portion 806 may have an ombre color scheme. However, the second portion 806 also includes a transparent section 814 (e.g., a transparent window), which enables a part 816 of the tank 802, such as a chimney, to be visible. By way of example, the transparent section 814 may be shaped to provide a specific indication, such as a company logo.

It should be noted that any of the illustrated first portions 400, 504, 706 may be configured to couple to any of the illustrated second portions 402, 506, 650, 708, 806. In other words, each second portion 402, 506, 650, 708, 806 may be interchangeably coupled to any of the first portions 400, 504, 708, 806 such that a battery may have any suitable combination of one of the first portions 400, 504, 706 coupled to one of the second portions 402, 506, 650, 708, 806. By way of example, in certain embodiments, a kit including one or more first portions (e.g., one or multiple of any of the first portions 400, 504, 706) and multiple second portions (e.g., one or multiple of any of the second portions 402, 506, 650, 708, 806) may be provided so that a user can selectively combine any subset of the first portion(s) and second portions to produce a particular battery.

Additionally, any of the vaporization devices 100, 700, 800 discussed herein may continue to operate without the respective second portions 402, 506, 650, 708, 750, 806. That is, each battery 310, 500, 704, 804 may operate while the respective first portions 400, 504, 706 are decoupled from the second portions 402, 506, 650, 708, 750, 806. Indeed, each battery 310, 500, 704, 804 may operate so long as the first portion 400, 504, 706 is attached to the tank 200, 702, 802 to provide electric power to heat a starting material regardless of whether a second portion is coupled to the first portion 400, 504, 706.

While the disclosure has been illustrated and described in detail and with reference to specific embodiments thereof, it is nevertheless not intended to be limited to the details shown, since it will be apparent that various modifications and structural changes may be made therein without departing from the scope the disclosure and within the scope and range of equivalents of the claims. For example, the shapes of the components shown in the Figures are not intended to be limiting and, in different embodiments, these components (as well as other components described herein) may have different shapes and/or sizes. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the components disclosed herein may be fabricated from any suitable material or combination of materials, provided that the components, or portions thereof, can function as described herein (i.e., withstand heating forces and/or form sealed connections). Example materials include plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Finally, it is intended that the present disclosure cover the modifications and variations of this disclosure that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure.

What is claimed is:

1. A vaporization device for an inhalable product, the vaporization device comprising:
a tank comprising a heater, wherein the tank is configured to receive a starting material, and the heater is configured to heat and vaporize the starting material to produce an inhalable vapor; and
a battery configured to provide electric power to the tank to operate the heater to heat and vaporize the starting material, wherein the battery comprises a first portion and a second portion configured to couple to one another, the first portion is attached to the tank, and the first portion and the second portion are configured to removably couple to one another.

2. The vaporization device of claim 1, comprising an additional second portion, wherein the second portion and the second portion are configured to interchangeably couple to the first portion.

3. The vaporization device of claim 1, wherein the first portion of the battery comprises a first section containing power-related components and a second section containing a battery cell.

4. The vaporization device of claim 3, wherein the second portion of the battery is configured to couple to the first section of the first portion of the battery.

5. The vaporization device of claim 4, wherein the second portion of the battery surrounds the second section of the first portion of the battery while coupled to the first section of the first portion of the battery.

6. The vaporization device of claim 5, wherein the second portion of the battery is at least partially transparent to enable the second section of the first portion of the battery to be visible through the second portion.

7. The vaporization device of claim 1, wherein the second portion comprises:
a first wall; and
a second wall surrounding the first wall to define a space extending between the first wall and the second wall, the space being configured to receive a material for providing a visual effect.

8. The vaporization device of claim 7, wherein the first wall is configured to couple to the first portion of the battery.

9. The vaporization device of claim 7, wherein the material comprises fluids producing a Rayleigh-Taylor instability interaction.

10. The vaporization device of claim 1, wherein the second portion of the battery comprises a tapered or flared surface.

11. The vaporization device of claim 1, wherein the second portion of the battery is configured to thread to the first portion of the battery.

12. The vaporization device of claim 1, wherein the first portion of the battery is integral with the tank.

13. The vaporization device of claim 12, wherein the second portion of the battery is configured to removably couple to the tank to removably couple to the first portion of the battery.

14. A battery for a vaporization device, the battery comprising:
a first portion containing power-related components and a battery cell, the first portion being configured to provide electric power to a tank of the vaporization device to operate a heater for vaporizing a starting material to produce an inhalable vapor; and
a second portion configured to removably couple to the first portion.

15. The battery of claim 14, wherein the first portion comprises a first section containing the power-related components and a second section containing the battery cell.

16. The battery of claim 15, wherein the second portion is configured to couple to the first section of the first portion and surround the second section of the first portion.

17. The battery of claim 16, wherein the second portion is at least partially opaque to block visibility of the second section of the first portion.

18. A kit for a vaporization device, the kit comprising:
a first portion of a battery, the first portion being configured to provide electric power to a tank of the vaporization device to operate a heater for vaporizing a starting material to produce an inhalable vapor;
a second portion of the battery configured to removably couple to the first portion; and
an additional second portion of the battery configured to removably couple to the first portion such that the second portion and the additional second portion are interchangeably couplable to the first portion.

19. The kit of claim 18, wherein the second portion and the additional second portion comprise different appearances.

20. The kit of claim 18, wherein each of the second portion of the battery and the additional second portion of the battery is configured to thread to the first portion of the battery to removably couple to the first portion.
